(19) United States
(12) Patent Application Publication
(10) Pub. No.: US 2026/0281100 A1
(43) Pub. Date: Sep. 17, 2026

(54) METHOD AND SYSTEM FOR AUTHENTICATION/AUTHORIZATION INTEGRATION USING SESSION STATE MACHINES IN LARGE LANGUAGE MODEL APPLICATION ENVIRONMENT

(71) Applicant: Vessl Al Korea Inc., Gwangju (KR)

(72) Inventors: Moon Kyung LIM, Yongin-si (KR); Seok Ju Hong, Seoul (KR)

(73) Assignee: Vessl Al Korea Inc., Gwangju (KR)

(21) Appl. No.: 19/300,794

(22) Filed: Aug. 15, 2025

(30) Foreign Application Priority Data
Mar. 11, 2025 (KR) 10-2025-0031068

(51) Int. Cl. H04L 9/40

(52) U.S. Cl. CPC H04L 63/083; H04L 63/102

(57) ABSTRACT

Disclosed is an authentication/authorization integration method using an internal authentication/authorization process in a large language model (LLM) application environment. The method includes providing, at a client, a request to an LLM agent, integrating, at the LLM agent, with an external tool to receive an authorization uniform resource identifier (URI) of a user for accessing the external tool and sending the authorization URI to the client, performing, at the client, an authentication/authorization process with an authorization server based on the authorization URI, generating, at the authorization server, an authorization code so as to be redirected to an authentication/authorization integration server, when the authentication/authorization process is successfully performed, and integrating, at the authentication/authorization integration server receiving the authorization code, with the authorization server such that an access token is issued and stored to and in the authentication/authorization integration server.

### CROSS-REFERENCE TO RELATED APPLICATIONS

This application claims priority under 35 U.S.C. § 119 to Korean Patent Application No. 10-2025-0031068 filed on Mar. 11, 2025, in the Korean Intellectual Property Office, the disclosures of which are incorporated by reference herein in their entireties.

### BACKGROUND

Embodiments of the present disclosure described herein relate to a method for authentication/authorization integration in an artificial intelligence agent system using a large language model (LLM), and more particularly, relate to an authentication/authorization integration method and an authentication/authorization integration system, which efficiently manage authentication/authorization and a session state necessary for an LLM agent to access an external tool or resource by using an internal authorization/authorization server for integration of various authentication/authorization manners and safe session management.

An existing large language model-based system mainly operates in such a way that an answer is provided based on pre-trained data. However, nowadays, a manner of accessing and using an external resource such as an external tool is emerging.

Application programming interface (API) integration is used as a manner where the large language model accesses the external resource, and session management and authentication for accessing the external resource are essential for the API integration.

As a conventional authentication and session management manner for accessing an external resource, there is used a manner of hard coding tokens to an external tool itself, a manner where the large language model receives and uses a token directly from a user, or a manner of delegating a token to an external service.

However, the conventional technologies have problems in security and usability. That is, when the token is hard-coded to the tool itself, all users may be recognized as one user with the same authority, and the users may access and read out data. The former makes it impossible to manage the authority for each user, and the latter causes a serious security risk. In the case of the manner where the large language model receives and uses a token directly from a user, the corresponding information is capable of being exposed to the outside through an external monitoring tool. Also, when conversation data are reused as training data, token information is capable of being leaked by malicious attacks such as prompt injection. In the case of the manner where the token is delegated to the external service, the external service itself may be vulnerable to the security, which causes additional security vulnerabilities in which sensitive authentication information of the user is exposed.

Accordingly, there is an increasing need for an authentication/authorization integration technology capable of overcoming the conventional issues and limitations.

Prior art document related to the present disclosure includes Korean Patent Publication No. 10-2023-0147840 (2023 Oct. 24).

### SUMMARY

Embodiments of the present disclosure provide a method and a system for authentication/authorization integration using an internal authorization/authorization process in a large language model application environment, which are capable of blocking the possibility of token leakage, removing external service dependency, and minimizing the possibility of token leakage such that a token is safely stored and managed centrally without directly sending user authorization information to a large language model through session management independent of a workflow of the large language model.

Embodiments of the present disclosure provide a method and a system for authentication/authorization integration using an internal authorization/authorization process in a large language model application environment, which are capable of performing authentication/authorization processing stably through integration of an LLM agent and an authorization session while providing an authorization session independent of a protocol such that authorization is smoothly processed during the lifecycle of the LLM agent.

Embodiments of the present disclosure provide a method and a system for authentication/authorization integration using an internal authorization/authorization process in a large language model application environment, which are capable of defining a profile unit and managing various authorization subjects in parallel even within the same thread.

Problems to be solved by the present disclosure are not limited to the above problems, and other problems not mentioned herein may be clearly understood from the specification and the accompanying drawings by one skilled in the art to which the present disclosure pertains.

According to an aspect of the present disclosure, an authentication/authorization integration method using an internal authentication/authorization process in a large language model (LLM) application environment may include providing, at a client, a request to an LLM agent, integrating, at the LLM agent, with an external tool to receive an authorization uniform resource identifier (URI) of a user for accessing the external tool and sending the authorization URI to the client, performing, at the client, an authentication/authorization process with an authorization server based on the authorization URI, generating, at the authorization server, an authorization code so as to be redirected to an authentication/authorization integration server, when the authentication/authorization process is successfully performed, and integrating, at the authentication/authorization integration server receiving the authorization code, with the authorization server such that an access token is issued and stored to and in the authentication/authorization integration server.

The authorization URI may be a string for identifying a specific resource on an Internet and may include a uniform resource locator (URL) indicating a location of the specific resource.

The performing of the authentication/authorization process may include providing, at the client, the authorization URI to a resource owner being the user, requesting, at the resource owner, authorization from the authorization server through a user agent, and authenticating, at the authorization server, the resource owner in response to the request and providing an authentication result to the user agent.

The generating of the authorization code so as to be redirected to the authentication/authorization integration server may include generating, at the authorization server, the authorization code, when the resource owner grants an access authority in response to the authentication result, and redirecting, at the authorization server, the generated authorization code to the user agent. The authorization code redirected to the user agent may be redirected to a server, and the authorization code redirected to the server may be redirected to the internal authentication/authorization integration server.

The integrating with the authorization server such that the access token is issued and stored to and in the authentication/authorization integration server may include setting, at the authentication/authorization integration server, a session state machine including a plurality of session states differently set depending on a change of a session, and individually managing, at the authentication/authorization integration server, the user's authentication/authorization session depending on the session state machine.

The session state machine may identify and set a session by using at least one of a profile of the user, a thread identifier, and a provider.

According to another aspect of the present disclosure, an authentication/authorization integration system using an internal authentication/authorization process in a large language model (LLM) application environment may include a client that provides a request, an LLM agent that receives the request, integrates with an external tool to receive an authorization uniform resource identifier (URI) of a user for accessing the external tool, and sends the authorization URI to the client, an authorization server that performs an authentication/authorization process with the client based on the authorization URI, and, when the authentication/authorization process is successfully performed, generates an authorization code and redirects the generated authorization code, the authorization server, and an authentication/authorization integration server that receives the redirected authorization code and integrates with the authorization server such that an access token is issued and stored to and in the authentication/authorization integration server.

Technical solutions of the present disclosure are not limited to the above solutions, and solutions which are not mentioned will be clearly understood by one skilled in the art to which the present disclosure pertains from the specification and the accompanying drawings.

### BRIEF DESCRIPTION OF THE FIGURES

The above and other objects, features and advantages of the present disclosure will become more apparent to those of ordinary skill in the art by describing exemplary embodiments thereof in detail with reference to the accompanying drawings.

FIG. 1 is a diagram describing an authentication/authorization integration system using an internal authentication/authorization process in a large language model application environment, according to an embodiment of the present disclosure.

FIG. 2 is a conceptual diagram for describing an authentication/authorization integration device using an internal authentication/authorization process in a large language model application environment, according to an embodiment of the present disclosure.

FIG. 3 is a flowchart describing a method of authorizing an API access of a user by using an OAuth protocol, according to an embodiment of the present disclosure.

FIG. 4 is a flowchart describing a method of authorizing an API access of a user by using a large language model and a tool, according to an embodiment of the present disclosure.

FIG. 5 is a flowchart describing an example of an authentication/authorization integration method using an external tool authorization service in a large language model environment, according to an embodiment of the present disclosure.

FIG. 6 is a flowchart describing an example of an authentication/authorization integration method using an internal authorization/authorization process in a large language model environment, according to an embodiment of the present disclosure.

FIG. 7 is a flowchart describing an example of a detailed process of the authentication/authorization integration method illustrated in FIG. 6.

FIG. 8 is a diagram illustrating an example of a state diagram describing a session state machine, according to an embodiment of the present disclosure.

FIG. 9 is a table illustrating an example of state transition of a session state of a session state machine.

FIG. 10 is a diagram illustrating a configuration example of a multi-profile and a thread ID, according to an embodiment of the present disclosure.

FIG. 11 is a block diagram for describing an authentication/authorization integration server using an internal authentication/authorization process in a large language model application environment, according to an embodiment of the present disclosure.

### DETAILED DESCRIPTION

Specific structural or functional descriptions which are described in the specification in association with various embodiments according to the present disclosure are provided only for the purpose of describing embodiments according to the present disclosure, and the embodiments according to the present disclosure may be carried out in various different forms, not limiting the embodiments described in the specification.

Because the embodiments according to the present disclosure are susceptible to various modifications and alternative forms, the embodiments will be shown as an example in the drawings and will be described in detail in the specification. However, the embodiments according to the present disclosure include modifications, equivalents, and alternatives falling within the spirit and scope of the present disclosure, not limiting the embodiments according to the present disclosure to particular forms disclosed herein.

Even though the terms “first”, “second”, etc. may be used to describe various components, the components should not be construed as being limited by the terms. These terms are only used to distinguish one element from another. For example, a first element may be termed a second element, and, similarly, the second element may be termed the first element, without departing from the scope of the present disclosure.

It should be understood that when a first component is referred to as being “connected” or “coupled” to a second component, the first component may be directly connected or coupled to the second component or intervening components may be present therebetween. In contrast, when a component is referred to as being “directly connected” or “directly coupled” to another component, it should be understood that any other component is not interposed therebetween. Expressions used to describe relationships between components, for example, “between” versus “directly between”, “adjacent” versus “directly adjacent,” etc. should be interpreted in a like fashion.

The terms used herein are only to describe specific embodiments and are not intended to limit the present disclosure. The articles “a”, “an”, and “the” are singular in that they have a single referent, but the use of the singular form should not preclude the presence of more than one referent. In the specification, it should be understood that the terms “comprises”, “comprising”, “includes”, “including”, etc. specify that described features, numbers, steps, operations, components, or parts or a combination thereof exists, but do not preclude the presence or addition of one or more other features, numbers, steps, operations, components, or parts or a combination thereof.

Unless otherwise defined, all terms including technical and scientific terms used herein have the same meaning as commonly understood by one of ordinary skill in the art to which the present disclosure pertains. It will be further understood that terms defined in commonly used dictionaries should be interpreted as having a meaning consistent with their meaning in the context of the related art and will not be interpreted in an idealized or overly formal sense unless expressly so defined herein.

In the specification, a processor may refer to hardware capable of performing a function and an operation according to each name described in the specification, may refer to a computer program code capable of performing a specific function and a specific operation, or may refer to an electronic recording medium equipped with a computer program code capable of performing a specific function and a specific operation.

In other words, the processor may refer to a functional and/or structural combination of hardware for carrying out the technical idea of the present disclosure and/or software for driving the hardware.

Below, embodiments will be described in detail with reference to the accompanying drawings. However, the scope of the patent application is neither limited nor restricted by the embodiments. The same reference numerals/signs in the drawings denote the same members.

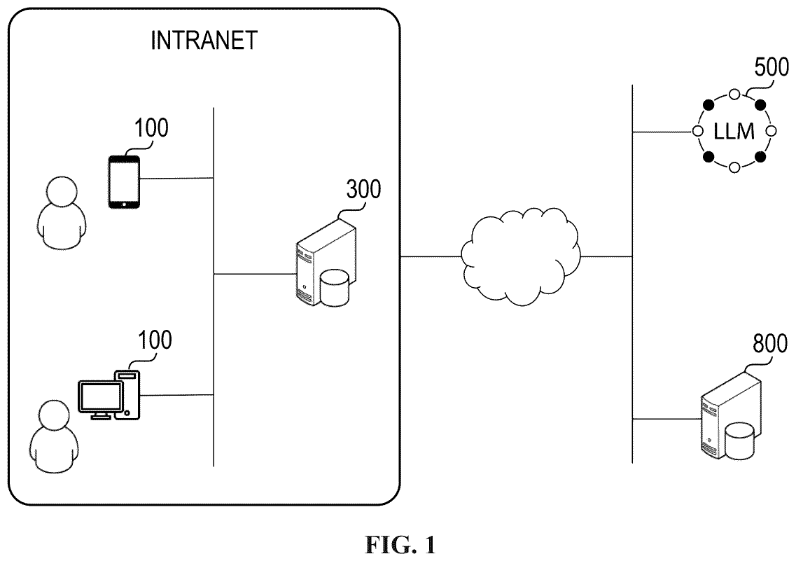

FIG. 1 is a diagram describing an authentication/authorization integration system using an internal authentication/authorization process in a large language model application environment, according to an embodiment of the present disclosure.

In FIG. 1, an authentication/authorization integration system using an internal authentication/authorization process in a large language model application environment (hereinafter referred to as an “authentication/authorization integration system”) may include a user terminal 100 and an authentication/authorization integration server 300 present in the same intranet as the user terminal 100. According to an embodiment, the authentication/authorization integration system may further include an authorization server (not illustrated).

The authentication/authorization integration system may operate based on a large language model 500 by integrating with the large language model 500 present inside or outside the intranet and an external tool 700.

The authentication/authorization integration system may manage authentication information for each profile or thread of a user, may integrate a lifecycle of an authentication session, and perform authentication independently of a protocol. To this end, the authentication/authorization integration system may perform update, authentication, etc., based on independent session management for each provider or profile.

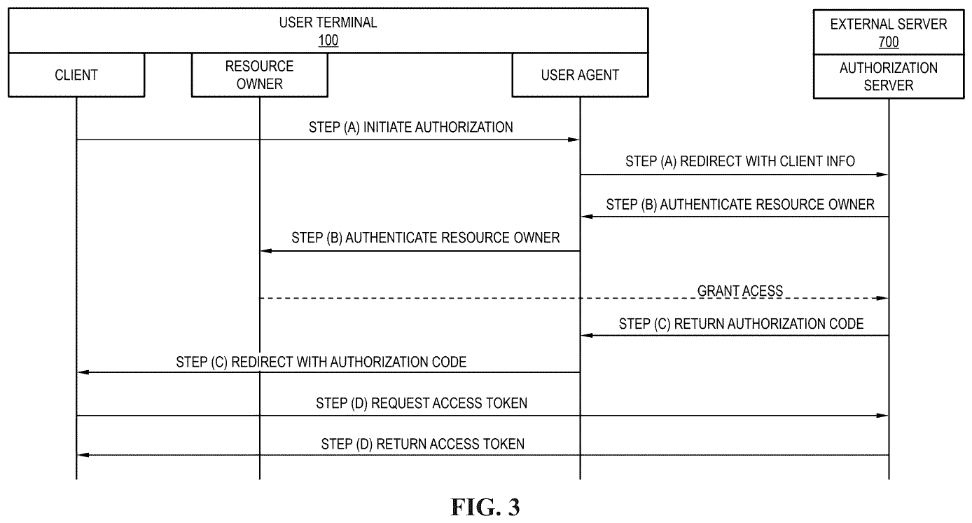

The authentication/authorization integration system may include the authorization server and the authentication/authorization integration server 300. The authorization server may perform a function of performing authentication and issuing an access token in an authentication/authorization flow. The authentication/authorization integration server 300 may integrate with the authorization server and may perform a function of requesting an access token from the authorization server based on an authorization code, receiving the access token from the authorization server as a response to the request, and storing the received access token. In FIG. 3 and below, each function will be described in detail in a state where the authorization server and the authentication/authorization integration server 300 are distinguished from each other. However, according to an embodiment, the authorization server and the authentication/authorization integration server 300 may be implemented as sub-functions of one server.

The user is a target which performs various services using the large language model 500 through the user terminal 100. The user terminal 100 refers to an electronic device such as a smart device (e.g., a smartphone), a personal computer (PC), or a portable laptop computer.

In FIG. 1, the user and the user terminal 100 may be collectively expressed. However, in FIG. 3 and below, the description will be given in detail in a state where the user and the user terminal 100 are distinguished from each other based on respective roles such as a resource owner, a client, and a user agent.

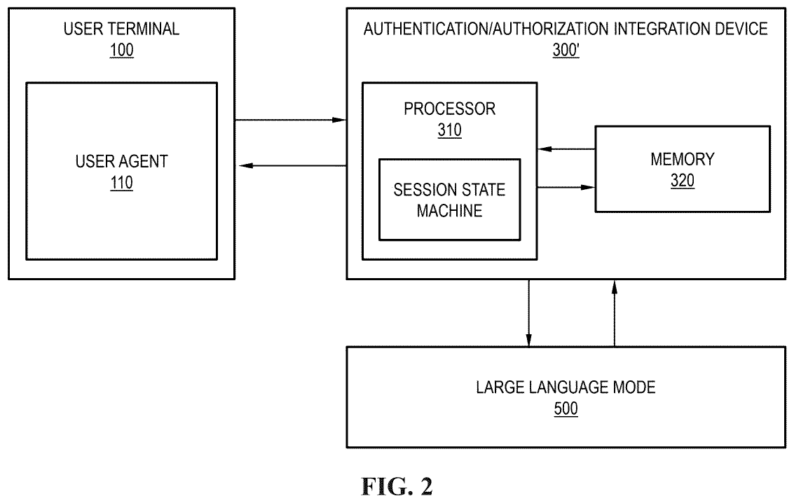

FIG. 2 is a conceptual diagram for describing an authentication/authorization integration device (hereinafter abbreviated as an “authentication/authorization integration device”) using an internal authentication/authorization process in a large language model application environment, according to an embodiment of the present disclosure.

The authentication/authorization integration device 300′ may include a processor 310 and a memory 320.

The authentication/authorization integration device 300′ may further include a communication module for communicative connection with the user terminal 100 through wireless communication or wired communication. The communication module may include a communication circuitry.

As an example, the processor 310 may include at least one of a microprocessor, a central processing unit, a processor core, a multi-core processor, a multiprocessor, an application-specific integrated circuit (ASIC), or a field programmable gate array (FPGA), but the present disclosure is not limited thereto.

The memory 320 may store instructions (or programs) executable by the processor 310. The memory 320 may include a volatile memory or a nonvolatile memory. The volatile memory may be implemented with a dynamic random access memory (DRAM), a static random access memory (SRAM), a thyristor RAM (T-RAM), a zero capacitor RAM (Z-RAM), or a twin transistor RAM (TTRAM). The nonvolatile memory may be implemented with an electrically erasable programmable read-only memory (EEPROM), a flash memory, a magnetic RAM (MRAM), a spin-transfer torque MRAM (STT-MRAM), a conductive bridging RAM (CBRAM), a ferroelectric RAM (FRAM), a phase change RAM (PRAM), a resistive RAM (RRAM), a nanotube RRAM, a polymer RAM (PoRAM), a nano floating gate memory (NFGM), a holographic memory, a molecular electronic memory device, or an insulator resistance change memory.

The authentication/authorization integration device 300′ may include a session state machine and may perform session management. The session state machine may refer to an artificial intelligence model or software module which operates individually. The session state machine may be implemented with a part of the processor 310, but the present disclosure is not limited thereto. For example, a separate processor may be used for each module.

The user terminal 100 refers to a device which the user uses. The user may be communicatively connected to the authentication/authorization integration device 300′ through the user terminal 100. The user terminal 100 which is a device such as a smart device (e.g., a smartphone), a personal computer (PC), or a portable laptop computer may drive a user agent 110 (or a program).

The authentication/authorization integration device 300′ may cooperatively operate with the user terminal 100 and the large language model 500 and may perform authentication/authorization processing for a request generated from the user terminal 100.

The authentication/authorization integration device 300′ may be an authentication/authorization integration server 300 to be described later. According to an embodiment, the authentication/authorization integration device 300′ may refer to a device which operates including a function of the authorization server and a function of the authentication/authorization integration server 300.

Various embodiments of an authentication/authorization integration method and an authentication/authorization integration system which use an internal authentication/authorization process in a large language model application environment according to the present disclosure will be described with reference to FIGS. 3 to 9.

Below, in the description of each component of the authentication/authorization integration system and an authentication method of the authentication/authorization integration system, the description will be given by using the terms which are defined as follows.

OAuth (Open Authorization) refers to an authentication/authorization protocol designed to allow a third-party application (i.e., a client) to access a resource with the limited authority without directly exposing qualification information of the user. For example, the OAuth may be an OAuth 2.0 standard protocol, which allows the client to safely access a protected resource through an access token issuing process.

The OAuth flow means an OAuth 2.0 authentication/authorization process, which may also be expressed as an authorization code grant flow. The OAuth flow starts with the authorization request of the client and includes a process in which the authorization server authenticates a resource owner and a process in which the authorization server issues the access token to the client. The redirect URI and the authorization code may be utilized in the above processes. The redirect URI is also known as a replay URL and indicates an address at which the resource owner which is successfully authenticated again goes back.

The resource owner means an end user which has the authority to access data or a resource in the OAuth flow. For example, when a user using a specific API grants an authority to access his or her account to a third-party application (i.e., a client), the user may correspond to the resource owner.

The authorization server refers to a server which performs authentication instead of the resource owner and issues the access token to a client application in the OAuth flow. For example, an OAuth authentication endpoint which is provided by Google, GitHub, Slack, etc. may be the authorization server.

The authentication/authorization integration server may perform a function of managing authentication information for each profile or thread of a user, integrating a lifecycle of an authentication session, and performing authentication/authorization independently of an authentication/authorization protocol. For example, the authentication/authorization integration server may perform operations of requesting the access token from the authorization server, storing the access token provided from the authorization server, and managing authentication information. The authentication/authorization integration server is marked as “Internal Auth. Server” in drawing.

A token refers to a string which is used by a client to prove authentication or authorization. The token may include an API token issued and sent directly by a user, as well as an OAuth-based access tokens and a refresh token. Examples of the API token may include a slack bot token, a GitHub personal access token, etc.

Below, various embodiments of an API authentication/authorization method performed when an application is driven will be described with reference to FIGS. 3 to 7.

FIG. 3 is a flowchart describing a method of authorizing an API access of a user by using an OAuth protocol, according to an embodiment of the present disclosure.

When the client initiates an authorization request, the user agent may redirect the authorization request to the external server 700, that is, the authorization server (refer to Step (A)).

Through an authorization process with the resource owner, the authorization server may perform a grant access from the resource owner and may be granted an authority (e.g., login) (refer to Step (B)).

Afterwards, the authorization server may issue an authorization code based on the granted authority and may provide the authorization code to the client (refer to Step (C)).

The client may connect to the authorization server based on the authorization code, may request the access token from the authorization server, and may be provided with the access token issued by the authorization server (refer to Step (D)). Afterwards, the client may be granted the access to a protected resource based on the access token.

In one embodiment illustrated in FIG. 3, the client may be issued with the authorization code without accessing actual authority information (e.g., an ID and a password for actual login) and may be issued with the access token of the user based on the authorization code. In this case, the access to a targeted resource server is capable of being authenticated.

That is, according to the method of authorizing the API access of the user, which is illustrated in FIG. 3, the access token may be dynamically issued and used by applying only the authority necessary for the application, and thus, the authority is capable of being managed safely and in detail.

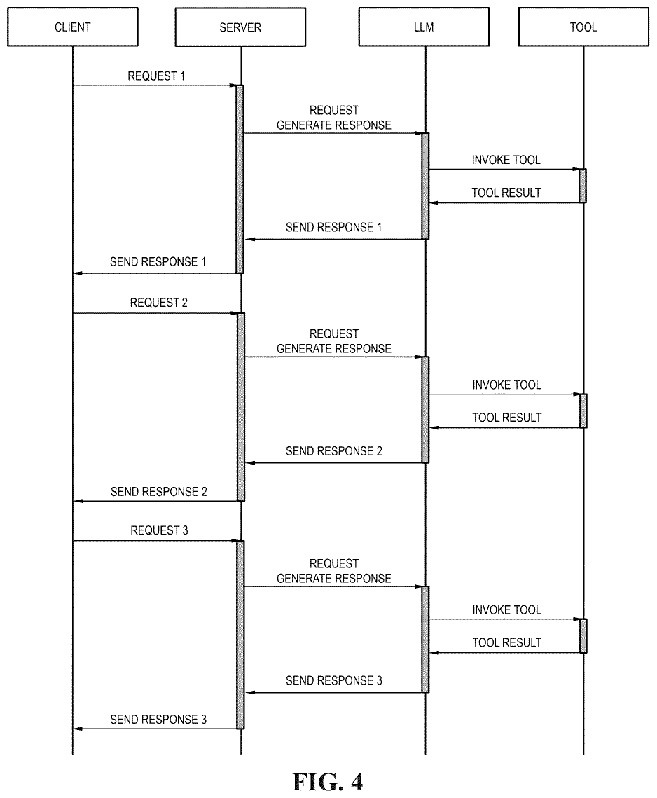

FIG. 4 is a flowchart describing a method of authorizing an API access of a user by using a large language model (LLM) and a tool, according to an embodiment of the present disclosure.

A conventional LLM system has a limitation of providing answers to user input based on pre-trained content. For this reason, nowadays, there is used an LLM agent system which allows the LLM to perform a function (e.g., an API call or integration with an external database) for integration with external data. The LLM agent may integrate with an external resource through API call and database search, may call a specific tool depending on a request of the user, or may plan and perform an executable task, that is, may provide action planning and execution functions.

A tool is used as an external function integrating with the LLM agent. That is, the tool which is a module for expanding the function of the LLM agent refers to a module which is capable of preforming calculation, search, and an automation task based on the user input, that is, capable of providing various usability.

The combination of the LLM agent and the tool opens up the possibility as a behavior-based interface in addition to simply providing an answer, and thus, the user experience may be significantly improved. However, for the integration with the LLM and an external API for using the tool, an authentication and authorization process for proving that the LLM is an agent of the user should be performed.

FIG. 4 is a diagram illustrating an LLM workflow sequence process between a client, a server, an LLM, and a tool.

Referring to FIG. 4, when the client provides a request (e.g., Request 1) to the server, the server requests the LLM to generate a response based on the request received from the client. The LLM invokes a tool necessary for response generation and generates a response (e.g., Response 1) based on a result provided from the tool so as to be provided to the server. The server sends the response (e.g., Response 1) provided from the LLM to the client.

In the above process, the LLM agent system may perform an additional task by invoking an external tool depending on a situation during the LLM workflow sequence. In this process, authentication logic is necessarily required to access an external resource. Accordingly, authentication may be performed by using a token in the above request process. That is, in association with each request, authentication may be performed by using a token which is directly issued to the user.

For example, when the user enters a request for “looking up today's meeting schedule on Google Calendar”, the LLM agent system may invoke a Google Calendar API to process the request; in this case, to look up Google calendar data of the user, authentication may be completed by using a token capable of proving that it is an agent of the user. That is, this corresponds to the case where the LLM agent receives and uses a token directly from the user. In this case, as described above, the token information may be exposed to the outside through an external monitoring tool. Also, when conversation data are reused as training data, token information may be leaked out due to malicious attacks such as prompt injection. Due to the above issues, the LLM agent system has many limitations in fetching the authentication information of the user.

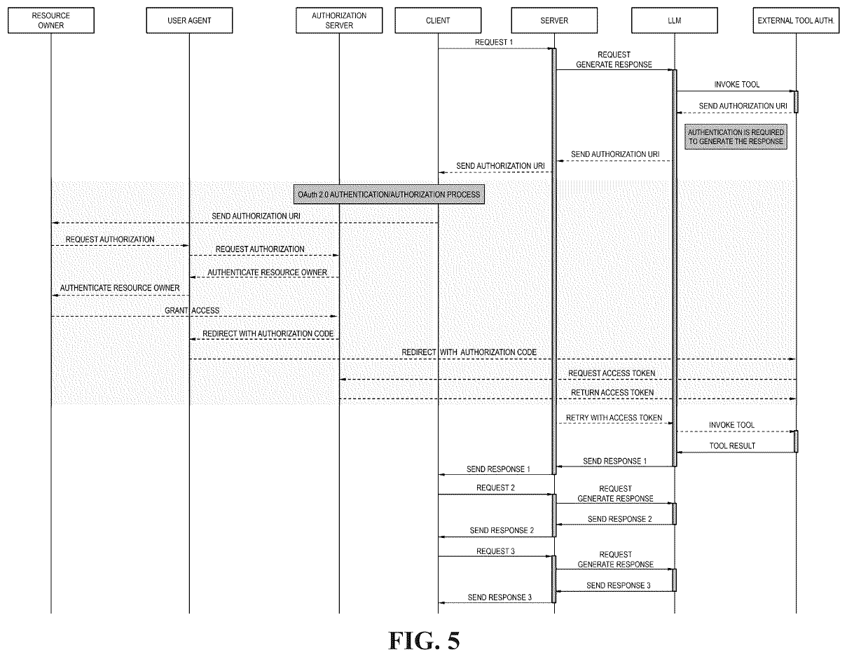

FIG. 5 is a flowchart describing an example of an authentication/authorization method using an external tool authentication service in a large language model environment, according to an embodiment of the present disclosure.

In FIG. 5, “LLM” indicates the LLM agent, and “External Tool Auth.” indicates an external tool authentication service.

Referring to FIG. 5, the LLM agent invokes the tool depending on the user request, which is described with reference to FIG. 4. Meanwhile, in an embodiment of the present disclosure, the OAuth 2.0 authentication/authorization process is performed in the tool invoke process.

That is, when the user should perform authentication, the external tool authentication service generates an authorization URI and sends the authorization URI to the user, that is, the resource owner. The authorization URI may be transferred to the resource owner through the LLM agent, the server, and the client.

Afterwards, the OAuth 2.0 authentication/authorization process may be performed. That is, the user may perform an authentication/authorization process with the authorization server through the user agent (e.g., a browser or an app) by using the authorization URI (refer to “OAuth 2.0 Authentication/Authorization Process”). In detail, the user may request authorization from the authorization server through the user agent, and the authorization server may authenticate the resource owner being the user in response to the request. When the resource owner is successfully authenticated, the authorization server redirects the authorization code to the user agent. Afterwards, the user agent redirects the authorization code to the external tool authorization service. Then, the external tool authorization service request an access token from the authorization server and receive the access token from the authorization server. This allows the authentication/authorization process to be completed.

The request of the LLM agent switches into a wait and retry state until the authentication/authorization process is completed. After the access token is issued, the server may be retrying an authorization-required request. When the LLM response for the retried request is generated by the LLM agent, the server may receive the generated LLM response and send the received LLM response to the client.

In an embodiment of the present disclosure, due to the limitation that token information of the user is stored in an external system, a security risk such as token leakage may exist.

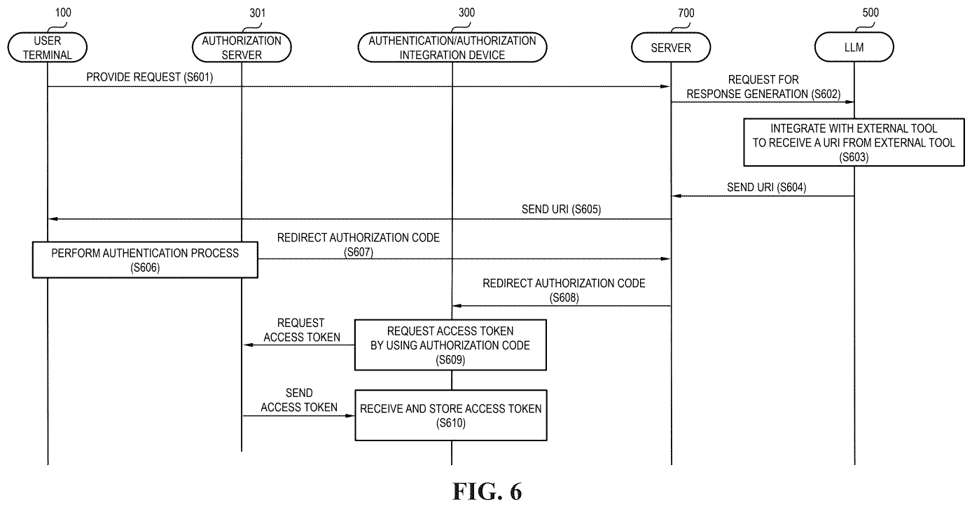

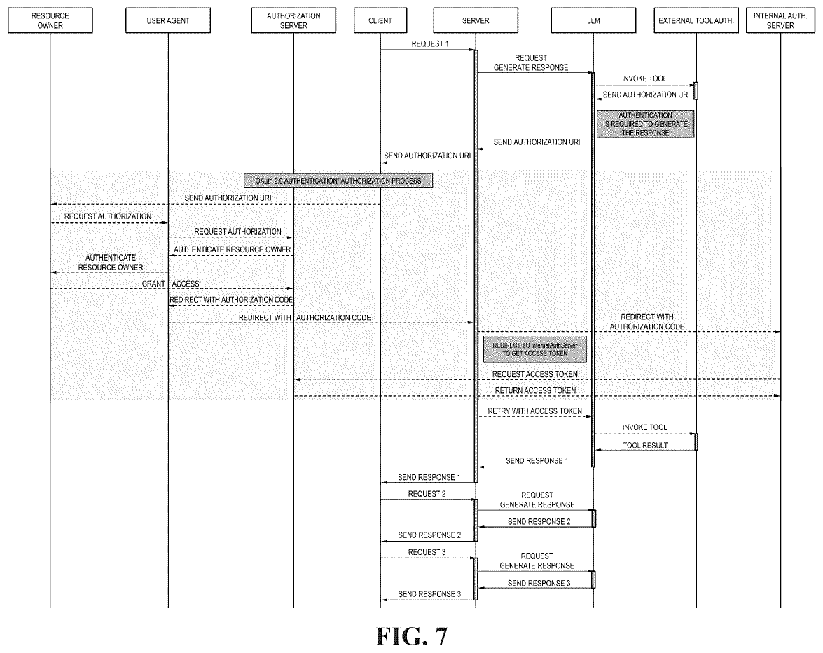

FIG. 6 is a flowchart describing an example of an authentication/authorization integration method using an internal authorization/authorization process in a large language model environment, according to an embodiment of the present disclosure, and FIG. 7 is a flowchart describing an example of a detailed process of the authentication/authorization integration method illustrated in FIG. 6.

An embodiment illustrated in FIGS. 6 and 7 is associated with an internal authorization/authorization process which makes it possible to supplement authentication security vulnerabilities in an existing LLM agent system, that is, a method of performing authentication integration by using an internal authentication/authorization process, that is, an internal authentication/authorization integration server.

Also, the embodiment illustrated in FIGS. 6 and 7 may solve the following issues variously present in existing session management.

That is, as an example of existing session management, in the case of the OAuth2 authenticated/authorized session, there is no manner of clearly defining or managing the lifecycle of the generated authenticated/authorized session.

In this case, when the authenticated/authorized session expires, it is impossible to refresh an existing session or to newly re-authenticate/re-authorize the existing session. In other words, re-authentication/re-authorization processing of the expired session is impossible.

Also, in the existing session management, when an authentication/authorization protocol (e.g., token-based authentication) other than the OAuth2 is used, due to the change of the authentication/authorization protocol, the session is incapable of being managed consistently. In other words, consistent session management for any other authentication/authorization protocol is impossible.

In addition, in the existing session management, when the authenticated/authorized session does not meet the scope of authority required for a specific request, the process of requesting additional authority or re-authenticating/re-authorizing is not effectively implemented. This means that the re-authenticating/re-authorization function for expanding the scope of authority is insufficient.

Furthermore, in the existing session management, when multiple resource owners are involved in a single conversation, session selection between the multiple resource owners is impossible in the LLM agent system, and it is impossible to satisfy complex authentication/authorization requirements between multiple profiles because there is no manner of managing multiple profiles.

In FIGS. 6 and 7, the above issues may be solved by changing an authentication/authorization process to an internal process by using the authentication/authorization integration server 300 being an internal authentication/authorization server.

Referring to FIG. 6, when the client of the user terminal 100 provides a request to a server 700 (S601), the server 700 may generate a request for response generation and may provide the request to the Large language model 500 (S602).

The Large language model 500 may integrate with an external tool to receive the uniform resource identifier (URI) for the user for accessing the external tool from the external tool (S603) and may send the received URI to the server 700 (S604). The server may send the URI to the client of the user terminal 100 (S605).

Herein, the URI which is a string for identifying a specific resource on the Internet may include an URL (Uniform Resource Locator) being an address indicating a location of the specific resource.

The client of the user terminal 100 may perform the authentication process with an authorization server 301 (S606) and may check authentication and session connection from the resource owner being the user. When the check is successfully performed, the client of the user terminal 100 may redirect an authorization code to the server 700 (S607), and the server 700 may redirect the authorization code to the authentication/authorization integration server 300 (S608). An embodiment in which the authorization code is redirected to the authentication/authorization integration server 300 through the server 700 is illustrated in FIG. 6 as an example, but the present disclosure is not limited thereto. For example, according to an embodiment, the redirection may be performed directly from the authorization server 301 to the authentication/authorization integration server 300.

Afterwards, an access token may be issued between the authentication/authorization integration server 300 and the authorization server 301, and lifecycle management for the access token is performed in the authentication/authorization integration server 300.

In detail, the authentication/authorization integration server 300 requests the access token from the authorization server 301 based on the authorization code (S609), and the authorization server 301 checks the authorization code and sends the access token corresponding to the authorization code to the authentication/authorization integration server 300. The authentication/authorization integration server 300 may receive and store the access token from the authorization server 301 (S610) and may perform authentication/authorization on the request of the client based on the stored access token.

FIG. 7 is a flowchart describing an example of a detailed process of the authentication/authorization integration method illustrated in FIG. 6.

In FIG. 7, “LLM” indicates an LLM agent, and “Internal Auth. Server” indicates an authentication/authorization integration server. “External Tool Auth.” Indicates an external tool authentication service, which will be abbreviated as an “external tool” in the following description.

Referring to FIG. 7, when a client of a user terminal provides a request to an LLM agent through a server, the server may request the LLM agent to generate a response.

The LLM agent may invoke the external tool, may receive the authorization URI of the user for accessing the external tool from the external tool, and may then send the received authorization URI to the client through the server.

The client may perform the authentication/authorization process with an authorization server (refer to “OAuth 2.0 Authorization Process”).

In detail, the client may send the authorization URI to a resource owner being the user. The resource owner which receives the authorization URI from the client requests authorization from the user agent, and the user agent provides the request of the resource owner to the authorization server.

The authorization server which receives the request from the user agent may authenticate the resource owner and provides an authentication result to the user agent. Afterwards, the resource owner may successfully perform the authentication/authorization process by granting the access authority in response to the received authentication result.

When the authentication/authorization process is successfully performed, the authorization server may generate the authorization code and may redirect the authorization code to an authentication/authorization integration server.

In detail, when the resource owner responds to the resource owner authorization, the authorization server may generate the authorization code. Afterwards, the authorization server may redirect the generated authorization code to the user agent, and the user agent may redirect the authorization code to the authentication/authorization integration server. An example in which the user agent redirects the authorization code through the server when redirecting the authorization code to the authentication/authorization integration server is illustrated in FIG. 7, but the present disclosure is not limited thereto.

When the authentication/authorization integration server receives the authorization code, the authentication/authorization integration server may integrate with the authorization server based on the authorization code to receive and store an access token issued by the authorization server.

In detail, the authentication/authorization integration server requests the access token from the authorization server based on the authorization code, and the authorization server checks the authorization code and returns the access token corresponding to the checked authorization code to the authentication/authorization integration server. The authentication/authorization integration server may store the access token which the authorization server returns and may perform authentication/authorization on the request of the client based on the stored access token.

The authentication/authorization integration server may store and manage the access token and authentication information about the access token. Authentication/authorization integration management which is performed by the authentication/authorization integration server may be performed based on the session state machine.

For example, the authentication/authorization integration server may set the session state machine including a plurality of session states differently set depending on a change of a session and may individually manage a user's authentication/authorization session depending on the session state machine.

Herein, the session state machine may be configured to identify a session by using at least one of a profile of a user, a threshold identifier, and a provider.

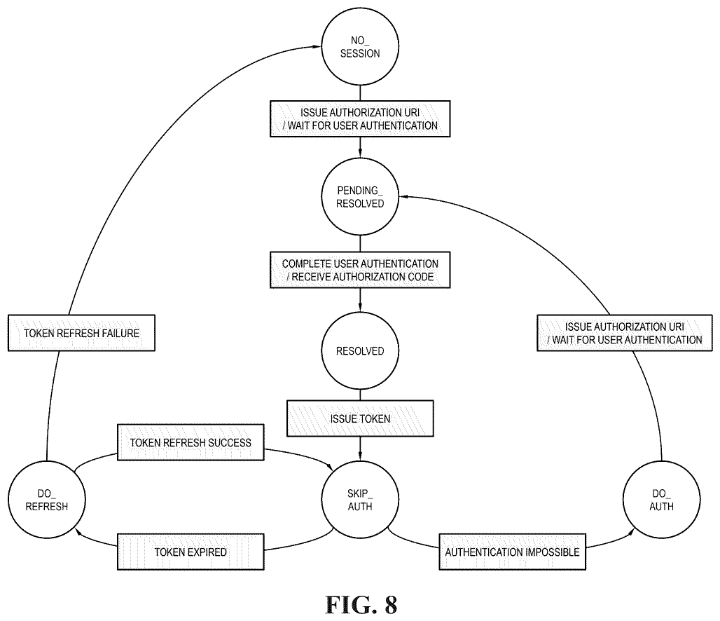

In this way, it may be possible to provide tracking management of a previous authentication/authorization state, management of multi-profile and provider, and management of session expiration and scope of authority. This will be described in detail with reference to FIG. 8.

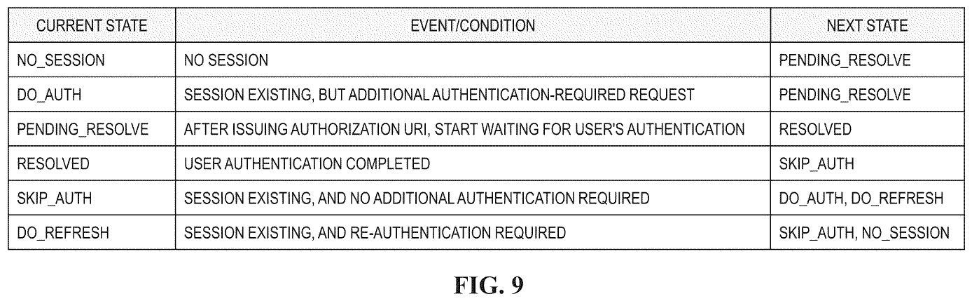

FIG. 8 is a diagram illustrating an example of a state transition table describing a session state machine, according to an embodiment of the present disclosure. FIG. 9 is a table illustrating an example of state transition of a session state of a session state machine.

The session state machine may systematically manage a complex authentication/authorization process of the LLM agent system, may clearly define each state, and may process the transition between states.

The session state machine may include a plurality of session states. For example, the session states may include NO_SESSION, PENDING_RESOLVED, RESOLVED, SKIP_AUTH, DO_AUTH, and DO_REFRESH.

Session state NO_SESSION means a state where there is no user authentication. The start condition of session state NO_SESSION is the case where the user first performs the authentication request or the case where a previous session expires. The transition condition of session state NO_SESSION is the case where the authorization URI is issued to the user and the authentication request is made to the user. That is, when the authorization URI is issued to the user and the authentication request is made to the user, session state NO_SESSION transitions to session state PENDING_RESOLVE.

Session state PENDING_RESOLVE means that the authentication/authorization integration server is waiting until the user completes authentication in an external browser using the authorization URI. The start condition of session state PENDING_RESOLVE is the case where the authorization URI is sent to the user and the authentication/authorization process progresses. The transition condition of session state PENDING_RESOLVE is the case where the authentication/authorization integration server receives the authorization code. That is, when the authentication/authorization integration serve receives the authorization code, session state PENDING_RESOLVE transitions to session state RESOLVED.

Session state RESOLVED means a state where as authentication is completed, the access token is being prepared for issuance. The start condition of session state RESOLVED is the case where the authentication/authorization integration server receives the authorization code. That is, when the authentication/authorization integration server receives the authorization code, session state RESOLVED starts. The transition condition of session state RESOLVED is the case where the issuance of the access token is completed. That is, when the issuance of the access token is completed, session state RESOLVED transitions to session state SKIP_AUTH.

Session state SKIP_AUTH means a state where an authentication is completed, a necessary scope of authority is satisfied and the access token is valid. The start condition of session state SKIP_AUTH is the case where the access token is issued and all request conditions are satisfied. That is, when the access token is issued and all the request conditions are satisfied, session state SKIP_AUTH starts. The transition condition of session state SKIP_AUTH is the case where the access token expires or when an additional scope is required. That is, when the access token expires, session state SKIP_AUTH transitions to session state DO_REFRESH. Also, when the additional scope is required, session state SKIP_AUTH transitions to session state DO_AUTH. Authentication is complete, the required permissions are met, and the access token is valid. The scope of required permissions is met and the access token is valid.

Session state DO_AUTH means a state where authentication information exists but the scope necessary for a current request or provider authentication is insufficient. The start condition of session state DO_AUTH is the case where the current session does not satisfy the scope or the case where authentication of another provider is required. That is, when the current session does not satisfy the scope or when authentication of another provider is required, session state DO_AUTH starts. The transition condition of session state DO_AUTH is the case where the authorization URI is reissued and the authentication request is made. That is, when the authorization URI is reissued and the authorization request is made, session state DO_AUTH transitions to session state PENDING_RESOLVE.

Session state DO_REFRESH means a state where the access token expires and there is an attempt to refresh the access token with a refresh token. The start condition of session state DO_REFRESH is the case where the access token expires. That is, when the access token expires, session state DO_REFRESH starts. The transition condition of session state DO_REFRESH is the case where the access token is successfully refreshed with the refresh token or the case where the refresh is failed. That is, when the access token is successfully refreshed with the refresh token, session state DO_REFRESH transitions to session state SKIP_AUTH. Alternatively, when the refresh is failed, session state DO_REFRESH may return to session state NO_SESSION, and a new session may be generated.

The session state makes it possible to track a previous authentication/authorization state. That is, the user authentication/authorization progress situation may be clearly tracked through the state-based transition. For example, when the user fails to complete authentication, the authentication progress may be checked by waiting in the “PENDING_RESOLVE” state.

In addition, when a session expires, the expired session can by automatically refreshed. For example, by attempting automatic refresh with the refresh token in the “DO_REFRESH” state and returning to the “NO_SESSION” state when the refresh is failed, user authentication may be induced again, that is, session refresh upon session expiration may be automated.

Also, extension and additional processing of the scope of authority are possible. For example, by transitioning to the “DO_AUTH” state when the additional scope is requested, the scope of authority may be dynamically extended through a new authentication request.

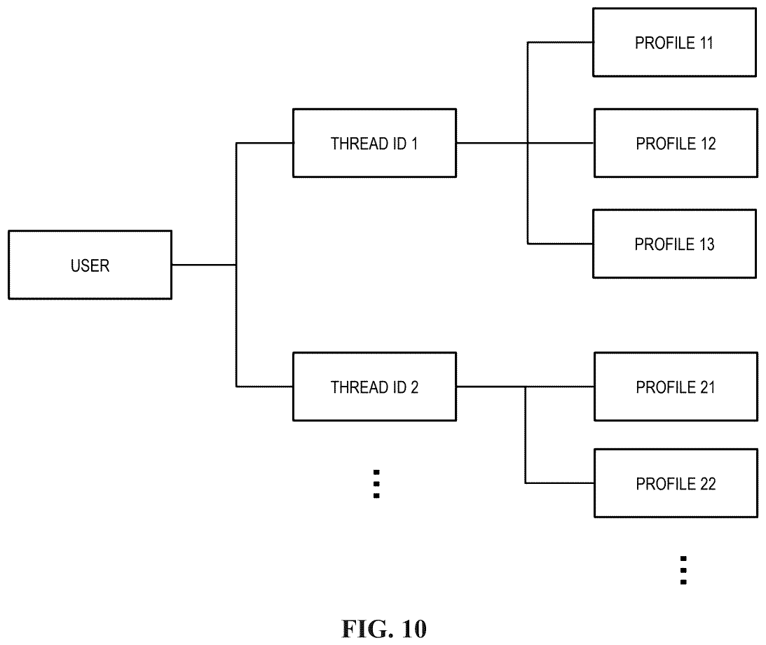

In addition, it may be possible to support multiple profiles and providers. FIG. 10 illustrates a configuration example of a multi-profile and a thread ID. Like an example of FIG. 10, a session may be independently managed based on at least one of a thread ID, a provider, and a profile for each user. In this way, various task flows may be stably processed even in the same thread.

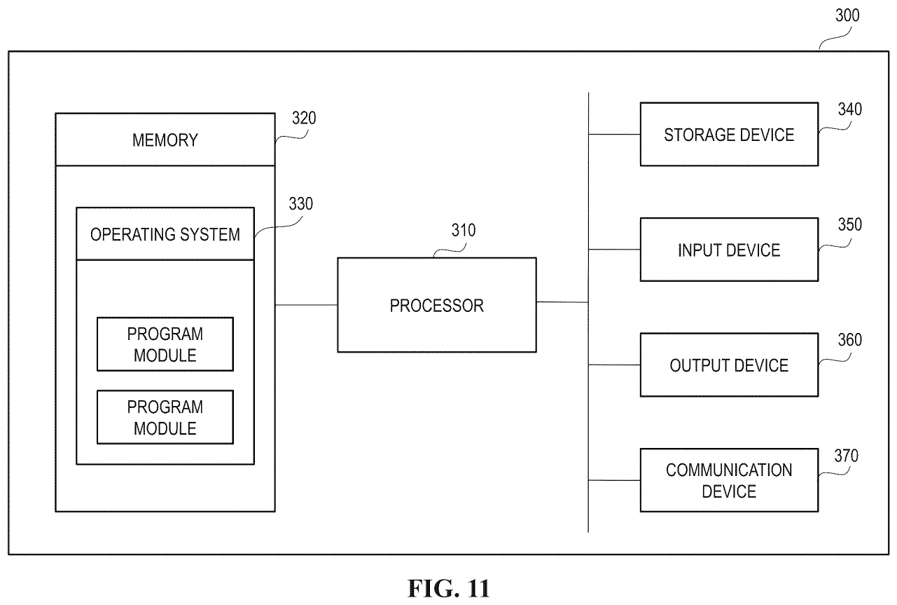

FIG. 11 is a block diagram for describing an authentication/authorization integration server using an internal authentication/authorization process in a large language model application environment, according to an embodiment of the present disclosure.

Referring to FIG. 11, the authentication/authorization integration server 300 may include the memory 320 including an operating system 330, the processor 310, a storage device 340, an input device 350, an output device 360, and/or a communication device 370.

The memory 320 may include a random access memory (RAM) and may provide a temporary storage space in which an operating system and program modules are executed. The memory 320 may temporarily store data and an instruction and may allow the processor 310 to quickly access and process the data.

The operating system 330 may include software. The operating system 330 may include memory management, file system management, processor management, and device management and may control programs executable within the device. The operating system 330 may include a program module, and the program module which is a software module for performing a specific function may provide or take charge of a user interface or a network.

The processor 310 may include a CPU, but the present disclosure is not limited thereto. The processor 310 may execute the instruction stored in the memory 320 and may process input data to generate a result or may perform a computational task.

The storage device 340 may include a device which semi-permanently stores data and a program.

The input device 350 which is a device receiving data from the user or any other system may include a keyboard, a mouse, a touch screen, or a display panel including a touch panel.

The output device 360 which is a device sending data processed through the processor 310 to the user or any other system may include a monitor, a speaker, or a display panel.

The communication device 370 may allow the authentication/authorization integration server 300 to be communicatively connected to an external network or any other device.

The foregoing devices may be implemented by a hardware component, a software component, and/or a combination of a hardware component and a software component. For example, the devices and the components described in the embodiments may be implemented by using one or more general-purpose computers or special-purpose computers, like a processor, a controller, an arithmetic logic unit (ALU), a digital signal processor, a microcomputer, a field programmable gate array (FPGA), a programmable logic unit (PLU), a microprocessor, or any device which may execute instructions and may respond thereto. A processing unit may execute an operating system (OS) or one or more software applications running on the operating system. Also, the processing unit may access, store, manipulate, process, and generate data in response to the execution of software. For convenience of understanding, the description is given as a single processing unit, but it will be understood by one skilled in the art that the processing unit may include a plurality of processing elements and/or a plurality of types of processing elements. For example, the processing device may include a plurality of processors or may include one processor and one controller. Also, any other processing configuration such as a parallel processor is possible.

Software may include a computer program, a code, an instruction, or one or more combinations thereof and may constitute a processing device to operate in a desired manner or may control the processing device independently or collectively. Software and/or data may be permanently or temporarily embodied in any type of a machine, a component, physical equipment, virtual equipment, a computer storage medium, or a computer device or in a transmitted signal wave, so as to be interpreted by the processing unit or to provide instructions or data to the processing unit. Software may be distributed on computer systems connected over a network so as to be stored therein or executed thereon. Software and data may be recorded in one or more computer-readable storage media.

The method according to the embodiment may be recorded in a computer-readable medium including a program instruction executable through various computer devices. The computer-readable medium may also include a program instruction, a data file, a data structure, or a combination thereof. The program instruction recorded in the medium may be designed and configured specially for the embodiment or may be known and available to one skilled in computer software. The computer-readable storage medium may include, for example, a hardware device, which is specially configured to store and execute a program instruction, such as a magnetic medium (e.g., a hard disk drive, a floppy disk or a magnetic tape), an optical medium (e.g. ;, CD-ROM or DVD), a magneto-optical medium (e.g., a floptical disk), a read only memory (ROM), a random access memory (RAM), or a flash memory. As an example, the program instruction includes not only a machine language code created by a compiler but also a high-level language code capable of being executed by a computer by using an interpreter or the like. The hardware device may be configured to act as one or more software modules to perform the operation of the embodiment, and vice versa.

Effects according to embodiments of the present disclosure are as follows. It may be possible to implement a safe session management system while preventing leakage of authorization information.

Since user authentication information is not directly sending to a large language model (LLM), the possibility of token leakage may be blocked through a session management system independent of a workflow of the LLM.

It may be possible to provide safer authorization management by safely storing and managing a token centrally such that a necessary token is directly inserted into a tool without referring to the LLM.

It may be possible to remove external service dependency and to minimize the possibility of token leakage, by deploying a component necessary for authentication/authorization on the workflow of the large language model.

It may be possible to define a lifecycle of an authentication/authorization session regardless of a protocol and to precisely implement the lifecycle of the authentication/authorization session. In this way, in a session management system which is operated independently of the LLM agent, the lifecycle such as generation/refresh/expiration of an authentication/authorization session may be systematically defined, and it may be possible to provide flexible session management not dependent on a specific authentication/authorization protocol, by applying a consistent session lifecycle even in an authentication/authorization protocol (e.g., token-based authorization) in addition to OAuth2 (Open Authorization 2.0).

Exposure of sensitive user information due to external attacks such as prompt injection may be prevented in advance by using the lifecycle of the authentication/authorization session independent of the protocol.

Independent session management for each provider and for each profile is provided. In this way, it may be possible to define a profile unit and to manage various authentication subjects (e.g., a provider and a scope of authority) in parallel even within the same thread. In addition, it is possible to effectively perform refresh and re-authenticating/re-authorization by separating the scope of authority and the authority for each profile.

Effects according to the present disclosure are not limited to the above effects, and effects not mentioned herein may be clearly understood from the specification and the accompanying drawings by one skilled in the art to which the present disclosure pertains.

Although the present disclosure has been described above with reference to the limited exemplary embodiments and drawings, various modifications and variations can be made from the above description by those of ordinary skill in the art. For example, even when the described techniques are performed in an order different from the method described above, and/or even when components of the described system, structure, device, circuit, and the like are coupled or combined in a form different from the way described above or replaced or substituted with other components or equivalents, an appropriate result can be achieved.

Therefore, other implementations, other embodiments, and equivalents to the claims fall within the scope of the following claims.

What is claimed is:

1. An authentication/authorization integration method using an internal authentication/authorization process in a large language model (LLM) application environment, the method comprising:
providing, at a client, a request to an LLM agent;
integrating, at the LLM agent, with an external tool to receive an authorization uniform resource identifier (URI) of a user for accessing the external tool and sending the authorization URI to the client;
performing, at the client, an authentication/authorization process with an authorization server based on the authorization URI;
when the authentication/authorization process is successfully performed, generating, at the authorization server, an authorization code so as to be redirected to an authentication/authorization integration server; and
integrating, at the authentication/authorization integration server receiving the authorization code, with the authorization server such that an access token is issued and stored to and in the authentication/authorization integration server.

2. The method of claim 1, wherein the authorization URI is a string for identifying a specific resource on an Internet and includes a uniform resource locator (URL) indicating a location of the specific resource.

3. The method of claim 1, wherein the performing of the authentication/authorization process with the authorization server based on the authorization URI at the user client includes:
providing, at the client, the authorization URI to a resource owner being the user;
requesting, at the resource owner, authorization from the authorization server through a user agent; and
authenticating, at the authorization server, the resource owner in response to the request and providing an authentication result to the user agent.

4. The method of claim 3, wherein the generating of the authorization code so as to be redirected to the authentication/authorization integration server includes:
when the resource owner grants an access authority in response to the authentication result, generating, at the authorization server, the authorization code; and
redirecting, at the authorization server, the generated authorization code to the user agent,
wherein the authorization code redirected to the user agent is redirected to a server, and
wherein the authorization code redirected to the server is redirected to the internal authentication/authorization integration server.

5. The method of claim 1, wherein the integrating with the authorization server such that the access token is issued and stored to and in the authentication/authorization integration server includes:
setting, at the authentication/authorization integration server, a session state machine including a plurality of session states differently set depending on a change of a session; and
individually managing, at the authentication/authorization integration server, the user's authentication/authorization session depending on the session state machine.

6. The method of claim 5, wherein the session state machine is configured to identify and set a session by using at least one of a profile of the user, a thread identifier, and a provider.

7. An authentication/authorization integration system using an internal authentication/authorization process in a large language model (LLM) application environment, comprising:
a client configured to provide a request;
an LLM agent configured to receive the request, to integrate with an external tool to receive an authorization uniform resource identifier (URI) of a user for accessing the external tool, and to send the authorization URI to the client;
an authorization server configured to perform an authentication/authorization process with the client based on the authorization URI, wherein, when the authentication/authorization process is successfully performed, the authorization server generates an authorization code and redirects the generated authorization code; and
an authentication/authorization integration server configured to receives the redirected authorization code and to integrate with the authorization server such that an access token is issued and stored to and in the authentication/authorization integration server.

8. A non-transitory computer-readable recording medium storing a computer program for executing an authentication/authorization integration method in a large language model (LLM) application environment, wherein the method includes:
providing, at a client, a request to an LLM agent;
integrating, at the LLM agent, with an external tool to receive an authorization uniform resource identifier (URI) of a user for accessing the external tool and sending the authorization URI to the client;
performing, at the client, an authentication/authorization process with an authorization server based on the authorization URI;
when the authentication/authorization process is successfully performed, generating, at the authorization server, an authorization code so as to be redirected to an authentication/authorization integration server; and
integrating, at the authentication/authorization integration server receiving the authorization code, with the authorization server such that an access token is issued and stored to and in the authentication/authorization integration server.
